(19) United States
(12) Patent Application Publication
(10) Pub. No.: US 2025/0203559 A1
(43) Pub. Date: Jun. 19, 2025

(54) METHOD AND SYSTEM OF WIRELESS COMMUNICATIONS

(71) Applicant: MEDIATEK INC., Hsin-Chu (TW)

(72) Inventors: Nathan Edward Tenny, San Jose, CA (US); Tao Chen, Beijing (CN); Xuelong Wang, Beijing (CN)

(73) Assignee: MEDIATEK INC., Hsin-Chu (TW)

(21) Appl. No.: 18/847,262

(22) PCT Filed: Jun. 14, 2023
(86) PCT No.: PCT/CN2023/100278

§ 371 Date: Sep. 15, 2024

(30) Foreign Application Priority Data
Jun. 14, 2022 (WO) PCT/CN2022/098684

(51) Int. Cl. H04W 64/00; G01S 11/06; H04W 24/10; H04W 92/18

(52) U.S. Cl. CPC H04W 64/00; G01S 11/06; H04W 24/10; H04W 92/18

(57) ABSTRACT

This disclosure provides methods, apparatuses, and non-transitory computer-readable mediums for wireless communication. One method at a first user equipment (UE) includes sending, to a positioning server and via a second UE, a first message including status indication information indicating that the first UE is a remote UE in a sidelink communication between the first UE and the second UE. Another method at a positioning server includes receiving, from a first UE and via a second UE, a first message including status indication information indicating that the first UE is a remote UE in a sidelink communication between the first UE and the second UE.

### TECHNICAL FIELD

The present disclosure claims priority to International Application No. PCT/CN2022/098684, filed on Jun. 14, 2022. The disclosure of the prior application is incorporated herein by reference in its entirety.

### TECHNICAL FIELD

The present disclosure relates to wireless communications, and more specifically, to methods of determining a location of a remote user equipment (UE) receiving service from a cellular network via a relay UE.

### BACKGROUND

In certain cellular systems, such as 3GPP 5G New Radio (NR) from Rel-17 onward, a first user equipment (UE) may function in a relaying relationship with a second UE. For example, when the first UE is out of a direct coverage or in a poor coverage of a cellular network, and the second UE is in a good coverage of the cellular network, the second UE can deliver communications between the first UE and the cellular network. In this scenario, the first UE can be referred to as a remote UE and the second UE can be referred to as a relay UE. The remote UE can be referred to as being in an indirect service or having an indirect path to the cellular network, while the relay UE can be referred to as being in a direct service or having a direct path to the cellular network. The relay and remote UEs can communicate via a sidelink interface, such as a PC5 interface, in which radio resources are used for direct communication between UEs without an intervening network node.

There are many scenarios in which it is desirable to know a location of a UE, such as for an emergency call, a location-based service, a network optimization, and the like. For a UE in a direct service, the cellular network can exploit timing or directional information about the cellular air interface to determine the location of the UE. As one example, the UE can measure the relative timing of signals arriving from a plurality of transmit points (TPs) of the cellular network, determine time difference of arrival (TDOA) values for the plurality of TPs, and report the time differences to a positioning server, such as a location management function (LMF) or a secure user plane location (SUPL) platform (SLP).

### SUMMARY

Aspects of the disclosure provide a method of wireless communication at a first user equipment (UE). The method sending, to a positioning server and via a second UE, a first message including status indication information indicating that the first UE is a remote UE in a sidelink communication between the first UE and the second UE.

In an embodiment, the status indication information is used for obtaining location information of the first UE.

In an embodiment, the second UE is a relay UE in the sidelink communication between the first UE and the second UE.

In an embodiment, the status indication information indicates that the first UE is out of a coverage area of a cell operated by a base station that serves the second UE.

In an embodiment, the status indication information indicates a coverage quality of a cell operated by a base station that serves the second UE.

In an embodiment, the method includes receiving, from the positioning server and via the second UE, a second message that requests location information of the first UE, and sending, to the positioning server and via the second UE, a request for assistance data for a measurement of the location information of the first UE. The method includes receiving, from the positioning server and via the second UE, the assistance data for the measurement of the location information of the first UE. The method includes performing the measurement of the location information of the first UE based on the assistance data. In an example, the assistance data is determined by the positioning server based on the status indication information indicating the first UE is the remote UE in the sidelink communication.

In an embodiment, the method includes sending, to the positioning server and via the second UE, a measurement report of the location information of the first UE.

In an embodiment, both the first message and the second message are based on a same positioning protocol. In an example, the positioning protocol is an LTE positioning protocol.

In an embodiment, the status indication information includes a Boolean flag indicating whether the first UE is the remote UE in the sidelink communication between the first UE and the second UE.

In an embodiment, the status indication information includes an identifier of the second UE.

In an embodiment, the status indication information indicates a coverage metric for a base station that serves the second UE. In an example, the coverage metric is a received signal strength at the first UE of a signal transmitted from the base station.

In an embodiment, the status indication information indicates a coverage quality of the second UE. In an example, the coverage quality of the second UE includes a sidelink measurement of the sidelink communication between the first UE and the second UE.

In an embodiment, the status indication information indicates at least one of a time offset or a roundtrip time between the first UE and the second UE.

In an embodiment, the status indication information includes a plurality of indications each corresponding to one of a plurality of serving frequency layers used in the sidelink communication between the first UE and the second UE.

In an embodiment, the first message and the second message are based on different positioning protocols. In an example, the first message and the second message are based on location services protocol and LTE positioning protocol, respectively.

Aspects of the disclosure provide a first UE. Processing circuitry of the first UE sends, to a positioning server and via a second UE, a first message including status indication information indicating that the first UE is a remote UE in a sidelink communication between the first UE and the second UE.

In an embodiment, the status indication information is used for obtaining location information of the first UE.

In an embodiment, the second UE is a relay UE in the sidelink communication between the first UE and the second UE.

In an embodiment, the status indication information indicates that the first UE is out of a coverage area of a cell operated by a base station that serves the second UE.

In an embodiment, the status indication information indicates a coverage quality of a cell operated by a base station that serves the second UE.

In an embodiment, the processing circuitry receives, from the positioning server and via the second UE, a second message that requests location information of the first UE, and sends, to the positioning server and via the second UE, a request for assistance data for a measurement of the location information of the first UE. The processing circuitry receives, from the positioning server and via the second UE, the assistance data for the measurement of the location information of the first UE. The processing circuitry performs the measurement of the location information of the first UE based on the assistance data. In an example, the assistance data is determined by the positioning server based on the status indication information indicating that the first UE is the remote UE in the sidelink communication.

In an embodiment, the processing circuitry sends, to the positioning server and via the second UE, a measurement report of the location information of the first UE.

In an embodiment, both the first message and the second message are based on a same positioning protocol. In an example, the positioning protocol is an LTE positioning protocol.

In an embodiment, the status indication information includes a Boolean flag indicating whether the first UE is the remote UE in the sidelink communication between the first UE and the second UE.

In an embodiment, the status indication information includes an identifier of the second UE.

In an embodiment, the status indication information indicates a coverage metric for a base station that serves the second UE. In an example, the coverage metric is a received signal strength at the first UE of a signal transmitted from the base station.

In an embodiment, the status indication information indicates a coverage quality of the second UE. In an example, the coverage quality of the second UE includes a sidelink measurement of the sidelink communication between the first UE and the second UE.

In an embodiment, the status indication information indicates at least one of a time offset or a roundtrip time between the first UE and the second UE.

In an embodiment, the status indication information includes a plurality of indications each corresponding to one of a plurality of serving frequency layers used in the sidelink communication between the first UE and the second UE.

In an embodiment, the first message and the second message are based on different positioning protocols. In an example, the first message and the second message are based on location services protocol and LTE positioning protocol, respectively.

Aspects of the disclosure provide a method of wireless communication at a positioning server. The method includes receiving, from a first UE and via a second UE, a first message including status indication information indicating that the first UE is a remote UE in a sidelink communication between the first UE and the second UE.

In an embodiment, the status indication information is used for obtaining location information of the first UE.

In an embodiment, the second UE is a relay UE in the sidelink communication between the first UE and the second UE.

In an embodiment, the status indication information indicates that the first UE is out of a coverage area of a cell operated by a base station that serves the second UE.

In an embodiment, the status indication information indicates a coverage quality of a cell operated by a base station that serves the second UE.

In an embodiment, the method includes transmitting, to the first UE and via the second UE, a second message that requests location information of the first UE, and receiving, from the first UE and via the second UE, a request for assistance data for a measurement of the location information of the first UE. The method includes determining the assistance data based on the status indication message. The method includes transmitting, to the first UE and via the second UE, the assistance data for the measurement of the location information of the first UE. In an example, the assistance data is used by the remote UE to perform the measurement of the location information of the first UE.

In an embodiment, the method includes receiving, from the first UE and via the second UE, a measurement report of the location information of the first UE.

In an embodiment, both the first message and the second message are based on a same positioning protocol. In an example, the positioning protocol is an LTE positioning protocol.

In an embodiment, the status indication information includes a Boolean flag indicating whether the first UE is the remote UE in the sidelink communication between the first UE and the second UE.

In an embodiment, the status indication information includes an identifier of the second UE. In an embodiment, the status indication information includes a coverage metric for a base station that serves the second UE. In an example, the coverage metric is a received signal strength at the first UE of a signal transmitted from the base station.

In an embodiment, the status indication information indicates a coverage quality of the second UE. In an example, the coverage quality of the second UE includes a sidelink measurement of the sidelink communication between the first UE and the second UE.

In an embodiment, the status indication information indicates at least one of a time offset or a roundtrip time between the first UE and the second UE.

In an embodiment, the status indication information includes a plurality of indications each corresponding to one of a plurality of serving frequency layers used in the sidelink communication between the first UE and the second UE.

In an embodiment, the first message and the second message are based on different positioning protocols. In an example, the first message and the second message are based on location services protocol and LTE positioning protocol, respectively.

Aspects of the disclosure provide a positioning server. Processing circuitry of the positioning server receives, from a first UE and via a second UE, a first message including status indication information indicating that the first UE is a remote UE in a sidelink communication between the first UE and the second UE.

In an embodiment, the status indication information is used for obtaining location information of the first UE.

In an embodiment, the second UE is a relay UE in the sidelink communication between the first UE and the second UE.

In an embodiment, the status indication information indicates that the first UE is out of a coverage area of a cell operated by a base station that serves the second UE.

In an embodiment, the status indication information indicates a coverage quality of a cell operated by a base station that serves the second UE.

In an embodiment, the processing circuitry transmits, to the first UE and via the second UE, a second message that requests location information of the first UE, and receives, from the first UE and via the second UE, a request for assistance data for a measurement of the location information of the first UE. The processing circuitry determines the assistance data based on the status indication message. The processing circuitry transmits, to the first UE and via the second UE, the assistance data for the measurement of the location information of the first UE. In an example, the assistance data is used by the remote UE to perform the measurement of the location information of the first UE.

In an embodiment, the processing circuitry receives, from the first UE and via the second UE, a measurement report of the location information of the first UE.

In an embodiment, both the first message and the second message are based on a same positioning protocol. In an example, the positioning protocol is an LTE positioning protocol.

In an embodiment, the status indication information includes a Boolean flag indicating whether the first UE is the remote UE in the sidelink communication between the first UE and the second UE.

In an embodiment, the status indication information includes an identifier of the second UE.

In an embodiment, the status indication information includes a coverage metric for a base station that serves the second UE. In an example, the coverage metric is a received signal strength at the first UE of a signal transmitted from the base station.

In an embodiment, the status indication information indicates a coverage quality of the second UE. In an example, the coverage quality of the second UE includes a sidelink measurement of the sidelink communication between the first UE and the second UE.

In an embodiment, the status indication information indicates at least one of a time offset or a roundtrip time between the first UE and the second UE.

In an embodiment, the status indication information includes a plurality of indications each corresponding to one of a plurality of serving frequency layers used in the sidelink communication between the first UE and the second UE.

In an embodiment, the first message and the second message are based on different positioning protocols. In an example, the first message and the second message are based on location services protocol and LTE positioning protocol, respectively.

Aspects of the disclosure provide a non-transitory computer-readable medium storing instructions which when executed by an apparatus cause the apparatus to perform any one or a combination of the above methods.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows an exemplary relaying architecture according to embodiments of the disclosure;

FIG. 2 shows a set of exemplary protocol stacks for a layer 2 relaying architecture between a remote UE and a gNB via a relay UE according to embodiments of the disclosure;

FIG. 3 is a diagram illustrating an example of a protocol stack for communication between a remote UE and a positioning server in a layer 2 relaying architecture according to embodiments of the disclosure;

FIG. 4 illustrates an example of downlink positioning for a remote UE out of coverage according to embodiments of the disclosure;

FIG. 5 illustrates an example of enhanced cell ID positioning for a remote UE out of coverage according to embodiments of the disclosure;

FIG. 6 illustrates an exemplary process for a downlink positioning operation according to embodiments of the disclosure;

FIG. 7 illustrates an exemplary process for a downlink enhanced cell ID positioning operation according to embodiments of the disclosure;

FIG. 8 shows a flowchart outlining a process according to embodiments of the disclosure;

FIG. 9 shows a flowchart outlining a process according to embodiments of the disclosure; and

FIG. 10 shows an exemplary apparatus according to embodiments of the disclosure.

### DETAILED DESCRIPTION OF EMBODIMENTS

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

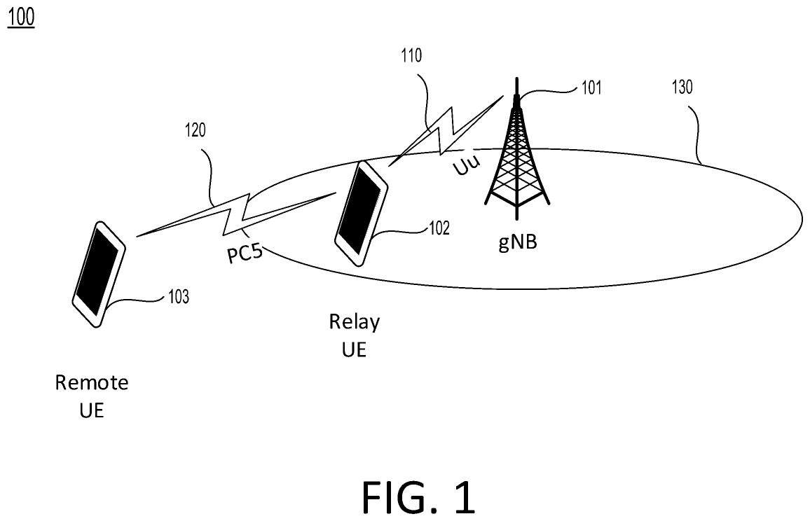

FIG. 1 shows an exemplary relaying architecture 100 according to embodiments of the disclosure. In the relaying architecture 100, a base station of a communication system, such as a gNB 101 in FIG. 1, can serve a first UE (or relay UE) 102 over a first direct interface, such as a Uu interface 110 shown in FIG. 1. In turn, the first UE 102 can serve a second UE (or remote UE) 103 over a second direct interface, such as a PC5 interface 120 shown in FIG. 1. The PC5 interface 120 can also be referred to as a sidelink interface.

In FIG. 1, the remote UE 103 is out of a coverage area 130 of a cell operated by the gNB 101. However, it should be noted that the relaying architecture 100 can also exist when the remote UE 103 is in the coverage area 130 of the cell operated by the gNB 101. For example, when the remote UE 103 is at an edge of the coverage area 130, the remote UE 103 may have a poor direct Uu link to the gNB 101. However, a better service between the remote UE 103 and the gNB 101 can be obtained through a combination of the good PC5 link 120 between the remote UE 103 and the relay UE 102 and the good Uu link 110 between the relay UE 102 and the gNB 101. Accordingly, communications to and from the remote UE 103 can be carried through the relay UE 102 from and to the gNB 101, allowing the remote UE 103 to be served by the communication system.

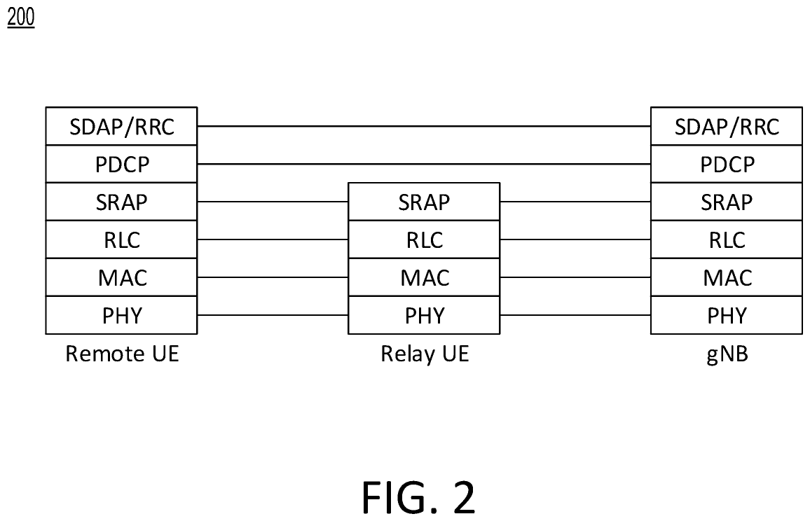

FIG. 2 shows a set of exemplary protocol stacks 200 for a layer 2 relaying architecture between a remote UE and a gNB via a relay UE according to embodiments of the disclosure. In an embodiment, the gNB, the relay UE, and the remote UE can the gNB 101, the relay UE 102, and the remote UE 103, respectively.

The protocol stacks 200 include a service data application protocol (SDAP) or a radio resource control (RRC) layer, a packet data convergence protocol (PDCP) layer, a sidelink relay application protocol (SRAP) layer, a radio link control (RLC) layer, a medium access control (MAC) layer, and a physical (PHY) layer. In the protocol stacks 200, a user-plane communication can be described when the top layer is SDAP, and a control-plane communication can be described when the top layer is RRC. One or more additional protocol layers (not shown) can be carried above the layers in FIG. 2, such as internet protocol (IP) over SDAP, or a non-access stratum (NAS) protocol over RRC. The SDAP, RRC, and PDCP layers can be respectively terminated end-to-end, between the remote UE and the gNB. The SRAP, RLC, MAC, and PHY layers can be respectively terminated hop-by-hop, between the remote UE and the relay UE and separately between the relay UE and the gNB. The relaying functionalities (for instance, routing, bearer mapping, and packet forwarding) can be embodied in the SRAP layer in an embodiment.

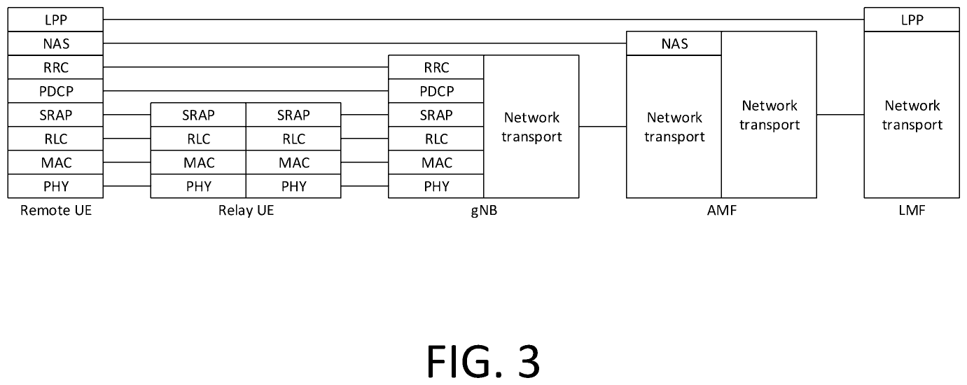

FIG. 3 shows a set of exemplary protocol stacks 300 for communication between a remote UE in a layer 2 relaying architecture and a location management function (LMF) in a communication system according to embodiments of the disclosure.

In an embodiment, the remote UE and the LMF can communicate using a positioning protocol, such as the LTE positioning protocol (LPP) shown in FIG. 3. An LPP layer can be terminated between the remote UE and the LMF. A NAS layer can be terminated between the remote UE and an access and mobility management function (AMF) in the communication system. The lower layers can be the same as the control-plane stack in FIG. 2. The gNB, the AMF, and the LMF can communicate via lower layers that can be described as network transport layers in FIG. 3. The network transport layers can provide transport for LPP.

It is noted that the AMF and/or the LMF may not have intrinsic knowledge that the AMF and/or the LMF are in correspondence with a remote UE. That is, from the standpoint of the AMF and/or the LMF, the remote UE may present itself as any other UE in the system. It is further noted that an alternative set of protocol stacks may apply in case positioning takes place over the user plane rather than the control plane, e.g., using a user-plane protocol such as a secure user-plane location (SUPL) protocol. In such a case, the user-plane protocol can carry a positioning protocol such as LPP, using a user-plane protocol stack (e.g., similar to the user-plane portion of FIG. 3) as transport.

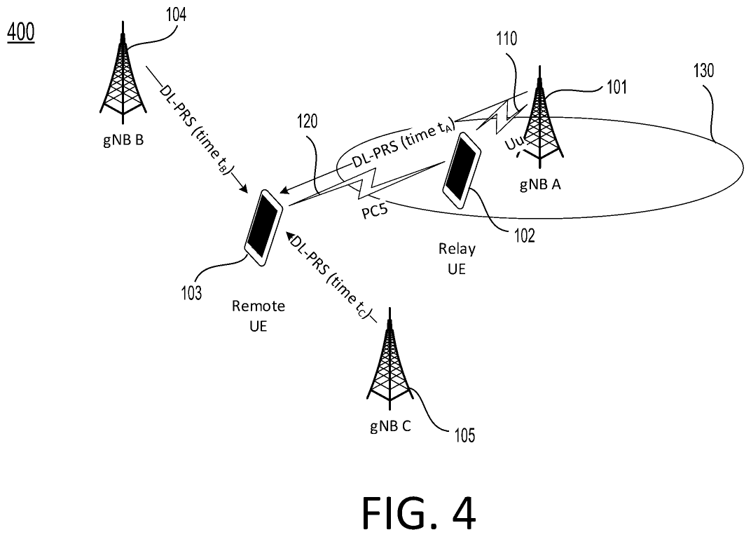

FIG. 4 shows an example of downlink time difference of arrival (DL-TDOA) positioning for a remote UE located outside a coverage area of a serving cell according to embodiments of the disclosure. In FIG. 4, a remote UE 103 can be served by a gNB A 101 via a relay UE 102, relying on a PC5 interface 120 between the remote UE 103 and the relay UE 102 and a Uu interface 110 between the relay UE 102 and the gNB A 101. The remote UE 103 can receive and measure downlink positioning reference signals (DL-PRS) from the gNB A 101 and neighboring gNBs B 104 and C 105, at respective times tA, tB, and tC. Each time difference of arrival (TDOA) between the DL-PRS from two gNBs can define a hyperbola with the gNBs at the foci. For example, the difference between tB and tA can define a hyperbola with the gNB B 104 at one focus and the gNB A 101 at the other focus. Intersecting the hyperbolae for a plurality of TDOA calculations, based on known locations of the gNBs, can provide an estimate of the location of the remote UE 103. The computation of the estimation can take place at the remote UE 103 or at a positioning server such as an LMF or an SLP.

It is noted that the DL-PRS may not be relayed in this disclosure. The direct arrow from the gNB A 101 to the remote UE 103 in FIG. 4 represents a direct reception and measurement of the DL-PRS by the remote UE 103, without forwarding through the relay UE 102. This direct measurement may be feasible for DL-PRS even if the remote UE 103 is out of coverage of a cell operated by the gNB A 101, because the DL-PRS design is optimized for hearability at range. Similarly, the remote UE 103 may not be in coverage from the standpoint of the gNB B 104 and/or gNB C 105, but the remote UE 103 may detect and measure the DL-PRS transmissions from the gNB B 104 and/or gNB C 105.

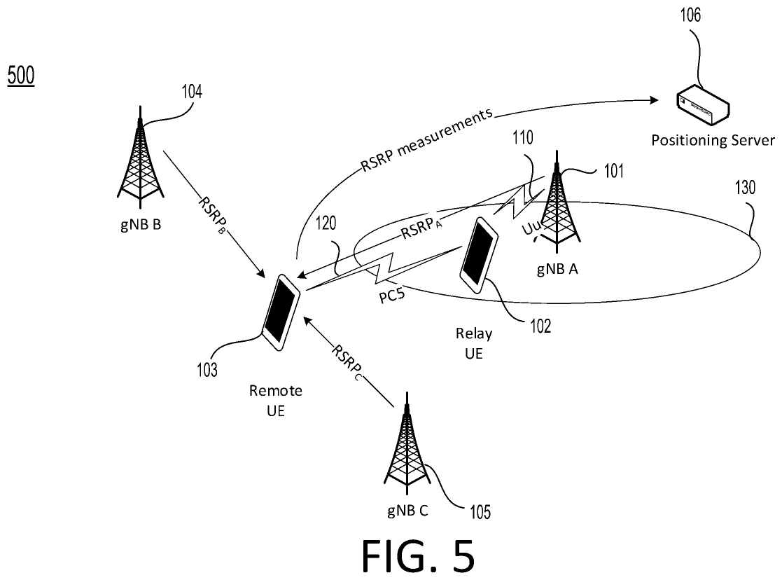

FIG. 5 shows an example of enhanced cell ID (E-CID) positioning for a remote UE located out of coverage of a serving cell according to embodiments of the disclosure. The configuration of remote and relay UEs and gNBs A, B, and C is the same as FIG. 4. The remote UE 103 can measure a variety of characteristics, such as reference signal received power (RSRP), from gNBs A, B, and/or C. The measurements can, for example, be taken on a synchronization signal block (SSB), a channel state information reference signal (CSI-RS) transmission, or other suitable signals from the gNBs. Other quantities, such as reference signal received quality (RSRQ), can be measured additionally or instead.

A choice of measurements for the remote UE 103 can be controlled by signaling (for instance, an LPP Request Location Information message) from a positioning server 106 such as an LMF or an SLP. The remote UE 103 can report the measurements to the positioning server 106, using a positioning protocol such as LPP. The communication of LPP signaling between the remote UE 103 and the positioning server 106 can rely on protocol stacks such as the protocol stacks 300 shown in FIG. 3. The positioning server 106 can use the reported measurements from the remote UE 103, together with serving cell information of the remote UE 103, to compute an estimated location for the remote UE 103.

An algorithm used to derive the estimated location from the measurements can be dependent on the positioning server 106. Since the positioning server 106 may be unaware of a status of the UE 103 as a remote UE, it may be assumed in the algorithm that the UE 103 to be positioned is located within a coverage area of a serving cell. This assumption can be reasonable for a UE in the coverage area, but it may be inaccurate for the remote UE 103, potentially giving rise to errors in the location estimation or a failure of the positioning operation. Accordingly, it may be beneficial to make the positioning server 106 be aware of the status of the remote UE 103.

This disclosure provides methods of making a positioning server be aware of the status of a remote UE.

According to aspects of the disclosure, this awareness can be achieved with an indication message from the remote UE to the positioning server. The indication message can be sent along with the transmission of the measurements from the remote UE to the positioning server. For instance, a flag can be added to an information element (IE) NR-ECID-SignalMeasurementInformation in LPP. In an embodiment, the flag can indicate that the UE to be positioned is a remote UE. In an embodiment, the flag can indicate that the UE to be positioned is out of coverage of a serving cell or a primary cell (PCell). The remote UE can determine a coverage status from criteria such as RSRP and/or RSRQ measurements of the cell. In an embodiment, the indication message can convey that the UE, which is out of coverage of the serving cell or the PCell, can still detect and measure a reference signal (e.g., DL-PRS) from the serving cell or the PCell.

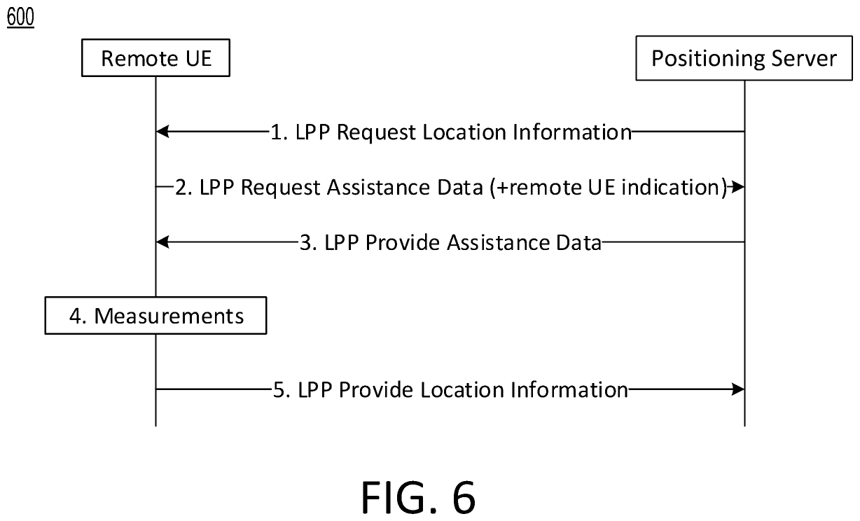

FIG. 6 shows an exemplary process 600 of a downlink positioning operation according to embodiments of the disclosure. Downlink here refers to an operation in which the measurements used for positioning are taken by the UE on signals in the downlink direction. The downlink positioning operation can be operated based on DL-TDOA or downlink angle of departure (DL-AOD). In the process 600, a remote UE (e.g., remote UE 103) can communicate with a positioning server (e.g., positioning server 106) via a positioning protocol. In an embodiment, the positioning server can be an LMF or an SLP, and the positioning protocol can be LPP or any positioning protocol with functionality similar to LPP.

At step 1, the positioning server can send an LPP Request Location Information message to request a downlink measurement from the remote UE. The downlink measurement can be used to estimate location information of the remote UE.

At step 2, the remote UE can send an LPP Request Assistance Data message to request assistance data for performing the downlink measurement. The LPP Request Assistance Data message can include a status indication of the remote UE. The status indication can indicate that the remote UE is a remote UE.

In an embodiment, the status indication can include an indication of a coverage status, e.g., an indication that the remote UE is out of coverage of a serving cell or a PCell. The remote UE can determine the coverage status, for instance, based on RSRP and/or RSRQ measurements of the serving cell. The coverage status can be compared to a coverage threshold such as a threshold used to define a suitable cell. The indication can be a Boolean flag or can contain additional information such as an identifier of a serving relay UE (e.g., relay UE 102), an estimated coverage quality of the serving cell or the PCell, and the like.

In an embodiment, the status indication can include proximity information of the remote UE to the relay UE, such as an estimated coverage quality of the relay UE (e.g., measurements of RSRP or RSRQ on the PC5 interface 120), a timing offset between the remote and relay UEs, a roundtrip time between the remote and relay UEs, and the like.

In an embodiment, when the remote UE communicates with the relay UE with a plurality of serving frequency layers, the status indication can include a plurality of indications each corresponding to one of the plurality of serving frequency layers. The plurality of indications can, for instance, be included in the IE CommonIEs-RequestAssistanceData in the Request Assistance Data message.

In an embodiment, the status indication can be included in a message of a protocol different from LPP, such as a location services (LCS) protocol or a supplementary services protocol. For example, the remote UE can send the status indication in a mobile originated location request (MO-LR) message to an AMF, and the AMF can pass the status indication, or information derived from the status indication, onward to the positioning server. The positioning server can then take the estimated location of the remote UE, the coverage conditions of the remote UE, the status as a remote UE, and/or any other information conveyed by the status indication into account in formulating the assistance data. As one example, an LMF can use the status indication to provide the assistance data covering a larger geographic area to a remote UE than to a UE in direct coverage, since the remote UE may be located further from a serving cell than the UE in direct coverage.

At step 3, the positioning server can send an LPP Provide Assistance Data message to the remote UE. The LPP Provide Assistance Data message can include the set of assistance data formulated by the positioning server based on the status indication received at step 2.

At step 4, the remote UE can take measurements such as DL-TDOA or DL-AOD measurements based on the set of assistance data included in the LPP Provide Assistance Data message.

At step 5, the remote UE can send an LPP Provide Location Information message to the positioning server. The LPP Provide Location Information message can include the measurements and/or a location estimate derived by the remote UE from the measurements.

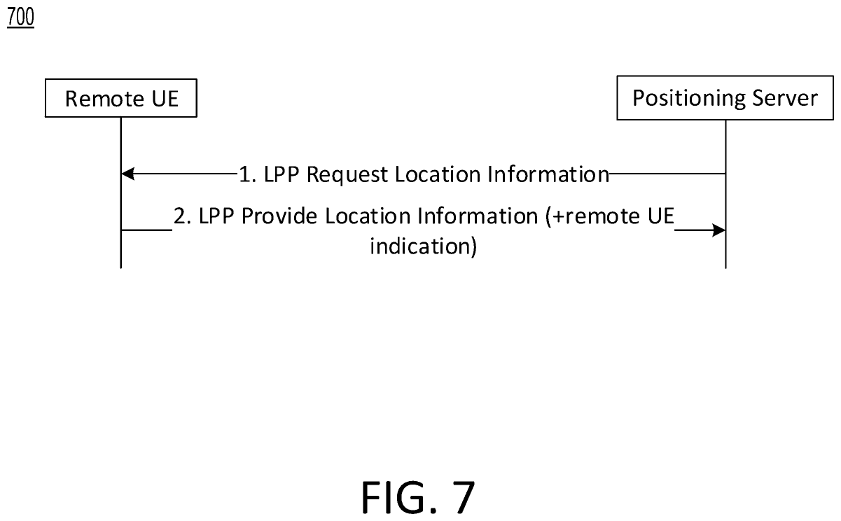

FIG. 7 shows an exemplary process 700 of a downlink E-CID positioning operation between a remote UE (e.g., remote UE 103) and a positioning server (e.g., positioning server 106), according to embodiments of the disclosure. In an embodiment, the positioning server can be an LMF or an SLP, and the remote can communicate with the positioning server using a positioning protocol such as LPP or any positioning protocol with functionality similar to LPP.

At step 1, the positioning server can send an LPP Request Location Information message to the remote UE to request E-CID measurements, such as RSRP or RSRQ measurements of SSB and/or CSI-RS transmissions.

At step 2, the remote UE can send an LPP Provide Location Information including the E-CID measurements and a status indication of the remote UE. The status indication can indicate that the remote UE is a remote UE.

In an embodiment, the status indication can include an indication of a coverage status, e.g., an indication that the remote UE is out of coverage of a serving cell or a PCell. The remote UE can determine a coverage status, for instance, based on RSRP and/or RSRQ measurements of the serving cell. The coverage status can be compared to a coverage threshold such as a threshold used to define a suitable cell. The indication can be a Boolean flag or can include additional information such as an identifier of a serving relay UE (e.g., relay UE 102), an estimated coverage quality of the serving cell or the PCell, and the like.

In an embodiment, the status indication can include proximity information of the remote UE to the relay UE, such as an estimated coverage quality of the relay UE (e.g., measurements of RSRP or RSRQ on the PC5 interface 120), a timing offset between the remote and relay UEs, a roundtrip time between the remote and relay UEs, and the like.

In an embodiment, when the remote UE communicates with the relay UE with a plurality of serving frequency layers, the status indication can include a plurality of indications each corresponding to one of the plurality of serving frequency layers. The plurality of indications can, for instance, be included in the IE CommonIEs-RequestAssistanceData in the Request Assistance Data message.

In an embodiment, the status indication can be included in a message of a protocol different from LPP, such as an LCS protocol or a supplementary services protocol. For example, the remote UE can send the indication in an MO-LR message to an AMF, and the AMF can pass the status indication, or information derived from the status indication, onward to the positioning server. The positioning server can then take the estimated location of the remote UE, the coverage conditions of the remote UE, its status as a remote UE, and/or any other information conveyed by the status indication into account in computing a location estimation. An exact usage of this information can be subject to an implementation of the positioning server.

It is noted that the process 700 in FIG. 7 may not include a step wherein the remote UE takes the requested measurements. In an embodiment, in the E-CID positioning, the remote UE may not take additional measurements for the purpose of positioning, but only report the measurements that are already available. The status indication of the remote UE can be included as a part of an indication of the serving cell or PCell in the Provide Location Information message.

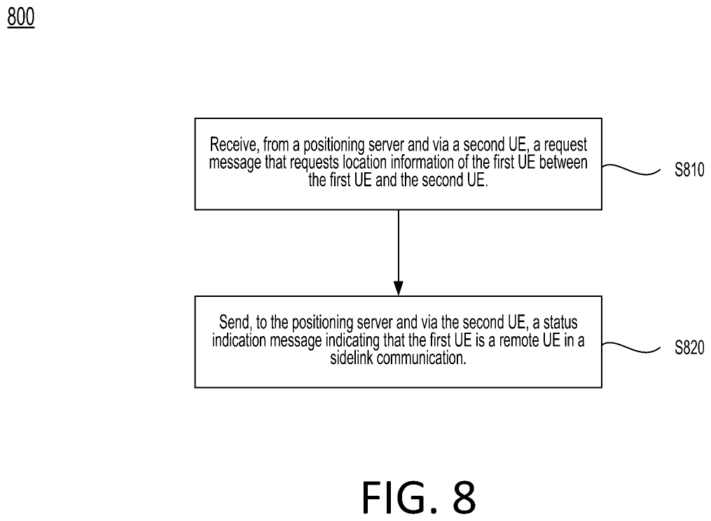

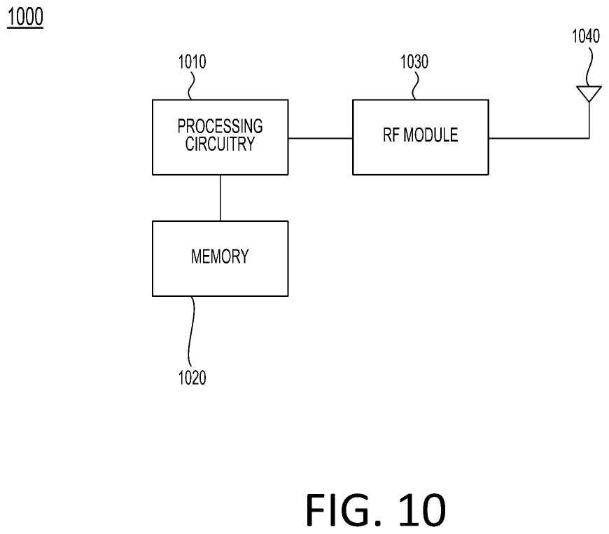

FIG. 8 shows a flowchart outlining a process 800 according to embodiments of the disclosure. The process 800 can be executed by processing circuitry of a first UE such as an apparatus 1000 in FIG. 10. The process 800 may start at step S810.

At step S810, the process 800 receives, from a positioning server and via a second UE, a request message that requests location information of the first UE. Then, the process 800 proceeds to steps S820.

At step S820, the process 800 sends, to the positioning server and via the second UE, a status indication message indicating that the first UE is a remote UE in a sidelink communication between the first UE and the second UE. Then, the process 800 may terminate.

In an embodiment, the second UE is a relay UE in the sidelink communication between the first UE and the second UE.

In an embodiment, the status indication message indicates that the first UE is out of a coverage area of a cell operated by a base station that serves the second UE.

In an embodiment, the status indication message indicates a coverage quality of a cell operated by a base station that serves the second UE.

In an embodiment, the process 800 sends, to the positioning server and via the second UE, a request for assistance data for a measurement of the location information of the first UE. The process 800 receives, from the positioning server and via the second UE, the assistance data for the measurement of the location information of the first UE. The process 800 performs the measurement of the location information of the first UE based on the assistance data. In an example, the assistance data is determined by the positioning server based on the status indication message.

In an embodiment, the process 800 sends, to the positioning server and via the second UE, a measurement report of the location information of the first UE.

In an embodiment, both the request message and the status indication message are based on a same positioning protocol. In an example, the positioning protocol is an LTE positioning protocol.

In an embodiment, the status indication message includes a Boolean flag indicating whether the first UE is the remote UE in the sidelink communication between the first UE and the second UE.

In an embodiment, the status indication message includes an identifier of the second UE.

In an embodiment, the status indication message indicates a coverage metric for a base station that serves the second UE. In an example, the coverage metric is a received signal strength at the first UE of a signal transmitted from the base station.

In an embodiment, the status indication message indicates a coverage quality of the second UE. In an example, the coverage quality of the second UE includes a sidelink measurement of the sidelink communication between the first UE and the second UE.

In an embodiment, the status indication message indicates at least one of a time offset or a roundtrip time between the first UE and the second UE.

In an embodiment, the status indication message includes a plurality of indications each corresponding to one of a plurality of serving frequency layers used in the sidelink communication between the first UE and the second UE.

In an embodiment, the request message and the status indication message are based on different positioning protocols. In an example, the status indication message and the request message are based on LCS and LPP, respectively.

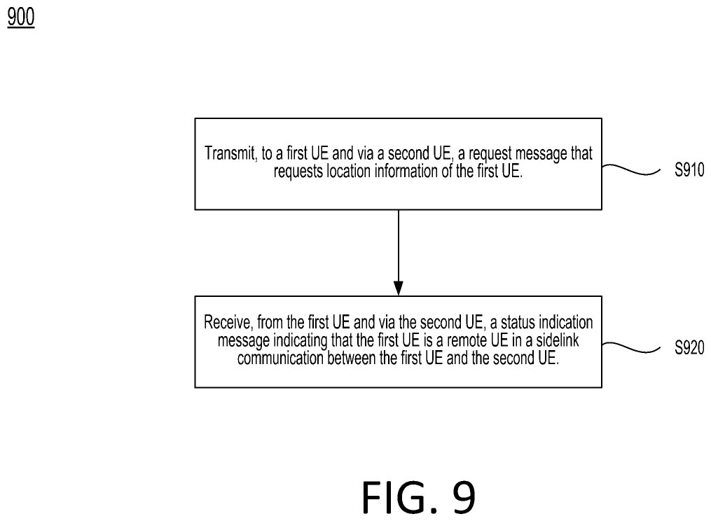

FIG. 9 shows a flowchart outlining a process 900 according to embodiments of the disclosure. The process 900 can be executed by processing circuitry of a positioning server such as an apparatus 1000 in FIG. 10. The process 900 may start at step S910.

At step S910, the process 900 transmits, to a first UE and via a second UE, a request message that requests location information of the first UE. Then, the process 900 proceeds to step S920.

At step S920, the process 900 receives, from the first UE and via the second UE, a status indication message indicating that the first UE is a remote UE in a sidelink communication between the first UE and the second UE. Then, the process 900 may terminate.

In an embodiment, the second UE is a relay UE in the sidelink communication between the first UE and the second UE.

In an embodiment, the status indication message indicates that the first UE is out of a coverage area of a cell operated by a base station that serves the second UE.

In an embodiment, the status indication message indicates a coverage quality of a cell operated by a base station that serves the second UE.

In an embodiment, the process 900 receives, from the first UE and via the second UE, a request for assistance data for a measurement of the location information of the first UE. The process 900 determines the assistance data based on the status indication message. The process 900 transmits, to the first UE and via the second UE, the assistance data for the measurement of the location information of the first UE. In an example, the assistance data can be used by the remote UE to perform the measurement of the location information of the first UE.

In an embodiment, the process 900 receives, from the first UE and via the second UE, a measurement report of the location information of the first UE.

In an embodiment, both the request message and the status indication message are based on a same positioning protocol. In an example, the positioning protocol is an LTE positioning protocol.

In an embodiment, the status indication message includes a Boolean flag indicating whether the first UE is the remote UE in the sidelink communication between the first UE and the second JE.

In an embodiment, the status indication message includes an identifier of the second UE.

In an embodiment, the status indication message includes a coverage metric for a base station that serves the second UE. In an example, the coverage metric is a received signal strength at the first UE of a signal transmitted from the base station.

In an embodiment, the status indication message indicates a coverage quality of the second UE. In an example, the coverage quality of the second UE includes a sidelink measurement of the sidelink communication between the first UE and the second UE.

In an embodiment, the status indication message indicates at least one of a time offset or a roundtrip time between the first UE and the second UE.

In an embodiment, the status indication message includes a plurality of indications each corresponding to one of a plurality of serving frequency layers used in the sidelink communication between the first UE and the second UE.

In an embodiment, the request message and the status indication message are based on different positioning protocols.

According to aspects of the disclosure, a method of wireless communication operable at a first UE is provided. The first UE operates in a relaying relationship with a second UE. The second UE is served by a base station. The first UE sends, to a positioning server and via the second UE, a request message of a positioning protocol. The request message includes a status indication of the first UE. The status indication indicates that the first UE is a remote UE in a sidelink communication between the first UE and the second UE.

According to aspects of the disclosure, a method of wireless communication operable at a positioning server is provided. The positioning server receives, from a first UE and via a second UE, a first message of a positioning protocol. The first message includes a status indication of the first UE. The status indication indicates that the first UE is a remote UE in a sidelink communication between the first UE and the second UE. The positioning server transmits, to the first UE and via the second UE, a second message of the positioning protocol. The second message includes assistance data for the first UE to perform a measurement of location information of the first UE.

According to aspects of the disclosure, a method of wireless communication operable at a positioning server is provided. The positioning server transmits, to a first UE and via a second UE, a first message of a positioning protocol. The first message includes a request for location information of the first UE. The positioning server receives, from the first UE and via the second UE, a second message of the positioning protocol. The second message includes a status indication of the first UE. The status indication indicates that the first UE is a remote UE in a sidelink communication between the first UE and the second UE.

FIG. 10 shows a block diagram of an apparatus 1000 according to embodiments of the disclosure. The apparatus 1000 can be configured to perform various functions in accordance with one or more embodiments or examples described herein. Thus, the apparatus 1000 can provide means for implementation of techniques, processes, functions, components, systems described herein. For example, the apparatus 1000 can be used to implement functions of the remote UE 103 or the positioning server 106 in various embodiments and examples described herein. The apparatus 1000 can be a general purpose computer in some embodiments, and can be a device including specially designed circuits to implement various functions, components, or processes described herein in other embodiments. The apparatus 1000 can include processing circuitry 1010, a memory 1020, a radio frequency (RF) module 1030, and an antenna 1040.

In various examples, the processing circuitry 1010 can include circuitry configured to perform the functions and processes described herein in combination with software or without software. In various examples, the processing circuitry can be a digital signal processor (DSP), an application specific integrated circuit (ASIC), programmable logic devices (PLDs), field programmable gate arrays (FPGAs), digitally enhanced circuits, or comparable device or a combination thereof.

In some other examples, the processing circuitry 1010 can be a central processing unit (CPU) configured to execute program instructions to perform various functions and processes described herein. Accordingly, the memory 1020 can be configured to store program instructions. The processing circuitry 1010, when executing the program instructions, can perform the functions and processes. The memory 1020 can further store other programs or data, such as operating systems, application programs, and the like. The memory can include transitory or non-transitory storage medium. The memory 1020 can include a read only memory (ROM), a random access memory (RAM), a flash memory, a solid state memory, a hard disk drive, an optical disk drive, and the like.

The RF module 1030 can include transceiver circuitry that are configured to receive processed data signal from the processing circuitry 1010 and transmit signals in a beam-formed wireless communication network via an antenna 1040, or receive and process signals from antenna 1040 and provides processed signals to the processing circuitry 1010. The RF module 1030 can include various circuit, such as receiving circuitry, transmitting circuitry, a digital to analog convertor (DAC), an analog to digital converter (ADC), a frequency up converter, a frequency down converter, filters, and amplifiers for reception and transmission operations, and the like. The RF module 1030 can include multi-antenna circuitry (e.g., analog signal phase/amplitude control units) for beamforming operations. The antenna 1040 can include one or more antenna arrays.

The apparatus 1000 can optionally include other components, such as input and output devices, additional or signal processing circuitry, and the like. Accordingly, the apparatus 1000 may be capable of performing other additional functions, such as executing application programs, and processing alternative communication protocols.

The processes and functions described herein can be implemented as a computer program which, when executed by one or more processors, can cause the one or more processors to perform the respective processes and functions. The computer program may be stored or distributed on a suitable medium, such as an optical storage medium or a solid-state medium supplied together with, or as part of, other hardware. The computer program may also be distributed in other forms, such as via the Internet or other wired or wireless telecommunication systems. For example, the computer program can be obtained and loaded into an apparatus, including obtaining the computer program through physical medium or distributed system, including, for example, from a server connected to the Internet.

The computer program may be accessible from a computer-readable medium providing program instructions for use by or in connection with a computer or any instruction execution system. The computer readable medium may include any apparatus that stores, communicates, propagates, or transports the computer program for use by or in connection with an instruction execution system, apparatus, or device. The computer-readable medium can be magnetic, optical, electronic, electromagnetic, infrared, or semiconductor system (or apparatus or device) or a propagation medium. The computer-readable medium may include a computer-readable non-transitory storage medium such as a semiconductor or solid state memory, magnetic tape, a removable computer diskette, a random access memory (RAM), a read-only memory (ROM), a magnetic disk and an optical disk, and the like. The computer-readable non-transitory storage medium can include all types of computer readable medium, including magnetic storage medium, optical storage medium, flash medium, and solid state storage medium.

When implemented in hardware, the hardware may comprise one or more of discrete components, an integrated circuit, an application-specific integrated circuit (ASIC), etc.

What is claimed is:

1. A method of wireless communication at a first user equipment (UE), the method comprising:
sending, to a positioning server and via a second UE, a first message including status indication information indicating that the first UE is a remote UE in a sidelink communication between the first UE and the second UE.

2. The method of claim 1, wherein the second UE is a relay UE in the sidelink communication between the first UE and the second UE.

3. The method of claim 1, wherein the status indication information indicates that the first UE is out of a coverage area of a cell operated by a base station that serves the second UE.

4. The method of claim 1, wherein the status indication information indicates a coverage quality of a cell operated by a base station that serves the second UE.

5. The method of claim 1, further comprising:
receiving, from the positioning server and via the second UE, a second message to request location information of the first UE;
sending, to the positioning server and via the second UE, a request for assistance data for a measurement of the location information of the first UE;
receiving, from the positioning server and via the second UE, the assistance data for the measurement of the location information of the first UE; and
performing the measurement of the location information of the first UE based on the assistance data.

6. The method of claim 5, wherein the assistance data is determined by the positioning server based on the status indication information indicating that the first UE is the remote UE in the sidelink communication.

7. The method of claim 1, further comprising:
sending, to the positioning server and via the second UE, a measurement report of the location information of the first UE.

8. The method of claim 5, wherein both the first message and the second message are based on a same positioning protocol.

9. The method of claim 8, wherein the positioning protocol is an LTE positioning protocol.

10. The method of claim 1, wherein the status indication information includes a Boolean flag indicating whether the first UE is the remote UE in the sidelink transmission between the first UE and the second UE.

11. The method of claim 1, wherein the status indication information includes an identifier of the second UE.

12. The method of claim 1, wherein the status indication information indicates a coverage metric for a base station that serves the second UE.

13. The method of claim 12, wherein the coverage metric is a received signal strength at the first UE of a signal transmitted from the base station.

14. The method of claim 1, wherein the status indication information indicates a coverage quality of the second UE.

15. The method of claim 14, wherein the coverage quality of the second UE includes a sidelink measurement of the sidelink communication between the first UE and the second UE.

16. The method of claim 1, wherein the status indication information indicates at least one of a time offset or a roundtrip time between the first UE and the second UE.

17. The method of claim 1, wherein the status indication information includes a plurality of indications each corresponding to one of a plurality of serving frequency layers used in the sidelink communication between the first UE and the second UE.

18. The method of claim 1, wherein the status indication information is used for obtaining location information of the first UE.

19. A first user equipment (UE), comprising:
processing circuitry configured to
send, to a positioning server and via a second UE, a first message including status indication information indicating that the first UE is a remote UE in a sidelink communication between the first UE and the second UE.

20. A non-transitory computer-readable medium storing instructions which when executed by a first user equipment (UE) cause the first UE to perform operations comprising:
sending, to a positioning server and via a second UE, a first message including status indication information indicating that the first UE is a remote UE in a sidelink communication between the first UE and the second UE.
